(19) United States
(12) Patent Application Publication
(10) Pub. No.: US 2026/0076398 A1
(43) Pub. Date: Mar. 19, 2026

(54) MICROPARTICLE COMPOSITIONS COMPRISING DIETARY FIBERS, METHODS OF MAKING, AND USE THEREOF

(71) Applicant: THE UNIVERSITY OF BRITISH COLUMBIA, Vancouver (CA)

(72) Inventors: Anubhav PRATAP-SINGH, Vancouver (CA); Alberto BALDELLI, Vancouver (CA); Rocio Silva ZAMORA, Vancouver (CA); Anika SINGH, Vancouver (CA)

(21) Appl. No.: 19/109,027

(22) PCT Filed: Sep. 6, 2023
(86) PCT No.: PCT/CA2023/051173

§ 371 Date: Mar. 5, 2025

Related U.S. Application Data
(60) Provisional application No. 63/403,901, filed on Sep. 6, 2022.

(51) Int. Cl. A23L 33/21; A23B 2/92; A23B 2/93

(52) U.S. Cl. CPC A23L 33/21; A23B 2/92; A23B 2/93

(57) ABSTRACT

Microparticle compositions comprising dietary fibers are disclosed. The microparticle compositions comprise a plurality of dietary fibers. In some embodiments, the plurality of dietary fibers comprise one or more hydrocolloids and one or more viscous fibers. In some embodiments, the one or more viscous fibers comprise a first viscous fiber and a second viscous fiber. The first viscous fiber may comprise a thickening agent. The first viscous fiber may comprise a bulking agent. In some embodiments, the plurality of dietary fibers further comprises one or more prebiotic fibers. One non-limiting example microparticle composition comprises chia mucilage, konjac glucomannan, psyllium husk, and inulin. Methods of making and method of use of the microparticle compositions are also disclosed.

### CROSS-REFERENCE TO RELATED APPLICATIONS

This application claims priority from U.S. application No. 63/403,901 filed 6 Sep. 2022 and entitled FAT MIMETICS: MICROENCAPSULATION OF DIETARY FIBER AT SIZES LESS THAN 10 μm, TO SERVE AS A FAT REPLACER which is hereby incorporated herein by reference for all purposes. For purposes of the United States of America, this application claims the benefit under 35 U.S.C. § 119 of US application No. U.S. application No. 63/403,901 filed 6 Sep. 2022 and entitled FAT MIMETICS: MICROENCAPSULATION OF DIETARY FIBER AT SIZES LESS THAN 10 μm, TO SERVE AS A FAT REPLACER which is hereby incorporated herein by reference for all purposes.

### FIELD OF THE INVENTION

This invention relates generally to microparticle compositions comprising dietary fibers, methods of making such microparticle compositions, and use thereof. Specific embodiments provide encapsulated dietary fiber microparticles that are suitable for use as fat replacement in food products.

### BACKGROUND

A high level of dietary fat consumption can contribute to various chronic diseases. While substituting fat and sugar in food products can be a potential solution, a more sustainable and healthy solution may be substituting with plant-based sources instead of total removal of fat from an individual's diet, or its' replacement with animal-based sources. A substitution process may involve removing fat from certain food products, and replacing it with water, air, protein or carbohydrates. Conventional fat replacers have been unsuccessful in reproducing the fat in food products. Conventional fat replacers lack at least one or more of the following desired characteristics of fat to serve as a fat mimetic: creaminess, appearance, palatability, texture and lubricity.

The inventors have recognized a general need for improved microparticle compositions comprising dietary fibers, and methods of making same. There is a particular need for microparticle compositions that are suitable for use as fat replacement in food products.

### SUMMARY

The invention has a number of aspects. One aspect of the invention relates to microparticle compositions comprising a plurality of dietary fibers. The plurality of dietary fibers comprise a first dietary fiber comprising one or more hydrocolloids, and a second dietary fiber comprising one or more viscous fibers. In some embodiments, the one or more viscous fibers comprise a mixture of a first viscous fiber and a second viscous fiber. In some embodiments, the plurality of dietary fibers further comprise a third dietary fiber comprising one or more prebiotic fibers.

In some embodiments, the first viscous fiber comprises a thickening agent. In some embodiments, the second viscous fiber comprises a bulking agent.

In some embodiments, the one or more hydrocolloids are selected from the group consisting of one or more of plant seed mucilage, xanthan, gums, alginate, pectin, carrageenan, gelatin, gellan, agar, cellulose and cellulose derivatives.

In some embodiments, the one or more viscous fibers are selected from the group consisting of one or more of konjac glucomannan, beta-glucans, pectins, gums, psyllium husk and konjac flour.

In some embodiments, the one or more prebiotic fibers comprise one or more oligosaccharides.

In some example embodiments, the plurality of dietary fibers comprise one or more of plant seed mucilage, konjac glucomannan, psyllium husk, and inulin.

In some example embodiments, the plurality of dietary fibers comprise 10-75% wt. of chia mucilage, 20-70% of konjac glucomannan, 0-80% of psyllium husk, and 0-90% of inulin.

In some example embodiments, the plurality of dietary fibers comprise 10-50% wt. of chia mucilage, 20-60% of konjac glucomannan, 2-30% of psyllium husk, and 5-40% of inulin.

In some embodiments, the microparticle compositions of the present invention have one or more of the following physiochemical properties:
high viscosity (e.g., greater than about 10 Pa·s);
high solubility (e.g., greater than about 70%);
high swelling capacity (e.g., greater than about 40%);
high emulsification stability (e.g., greater than about 40%);
high water holding capacity (e.g., greater than about 10%);
high oil holding capacity (e.g., greater than about 2%); and/or
low particle size (e.g., average diameter of the particles being less than about 60 μm).

One aspect of the invention relates to methods of making microparticle compositions comprising a plurality of dietary fibers. In some embodiments, the method comprises mixing one or more hydrocolloids and one or more viscous fibers in a solvent to form an emulsion, homogenizing the emulsion, and drying the emulsion to form microparticles having an average diameter of less than about 60 μm. In some embodiments, the method involves mixing one or more prebiotic fibers to the one or more hydrocolloids and the one or more viscous fibers to form the emulsion.

In some embodiments, the drying of the emulsion comprises one or more of spray-drying, freeze-drying, and spray freeze-drying the emulsion.

In some embodiments, the method further comprises pretreating one or more fiber sources to form the one or more hydrocolloids, viscous fibers, and prebiotic fibers before mixing with the solvent to form the emulsion. In some example embodiments, the pretreating comprises extracting one or more dietary fibers from a plant seed. In some example embodiments, the extracting comprises solubilizing the plant seed by mixing the plant seed in a solvent and separating the one or more dietary fibers from the plant seed. In some embodiments, the extracting further comprises dehydrating the one or more dietary fibers.

In some embodiments, the solubilizing comprises mixing the plant seed into the solvent by stirring and/or sonication (e.g., ultrasonication).

In some embodiments, the separating of the one or more dietary fibers from the plant seed comprises filtration and/or centrifugation.

In some embodiments, the dehydrating of the one or more prebiotic fibers comprises one or more of drum drying, pulse-combustion drying, hot air drying, microwave drying, vacuum drying, microwave vacuum drying, and freeze-drying.

One aspect of the invention relates to use of the microparticle composition to replace some or substantially all of the fat content in a food product.

One aspect of the invention relates to decreasing the total calories of a food product by greater than about 50%, and in some embodiments, by greater than about 70%, by replacing some or substantially all of the fat contained in the food product with the microparticle composition.

Another aspect of the invention relates to reducing the total unsaturated fat in a food product by greater than about 20% by replacing some or substantially all of the fat contained in the food product with the microparticle composition. Another aspect of the invention relates to reducing the total saturated fat in a food product by greater than about 50% by replacing some or substantially all of the fat contained in the food product with the microparticle composition.

Further aspects of the invention and features of specific embodiments of the invention are described below.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a flow chart illustrating example steps of making microparticle compositions according to an example embodiment.

FIG. 2A is a plot showing the yield as the dry weight of the extracted mucilage relative to the weight of the seed.

FIG. 2B is a plot showing the yield as the dry weight of the mucilage relative to the maximum mucilage which can be obtained.

FIG. 3A is a photograph of the chia seeds mixture which was solubilized by magnetic stirring.

FIG. 3B is a photograph of the chia seeds mixture which was solubilized by ultrasonication.

FIG. 3C is a photograph of the chia seeds mixture when the mucilage was separated by filtration using a mesh.

FIG. 3D is a photograph of the chia seeds mixture when the mucilage was separated by filtration using centrifugation.

FIG. 3E is a photograph of the separated mucilage when the mucilage was dehydrated by microwave vacuum dehydration.

FIG. 3F is a photograph of the separated mucilage when the mucilage was dehydrated by a hot air oven.

FIG. 3G is a photograph of a final extracted mucilage product.

FIG. 3H is an SEM image of the mucilage that was extracted by M8 at 100 μm.

FIG. 4 is a plot showing the total weight of the emulsions containing the dietary fibers before spray drying against the different microparticle compositions that were tested.

FIG. 5 is a table showing several morphological aspects of the tested spray dried microparticle compositions.

FIG. 6A is IR spectra of the spray-dried microparticles as compared to pure dietary fibers comprising inulin.

FIG. 6B is IR spectra of the spray-dried microparticles as compared to pure dietary fibers comprising glucomannan.

FIG. 6C is IR spectra of the spray-dried microparticles as compared to pure dietary fibers comprising psyllium husk.

FIG. 6D is IR spectra of the spray-dried microparticles as compared to pure dietary fibers comprising chia mucilage.

FIG. 7 is a plot showing the results of the descriptive analysis.

FIG. 8A is a photograph showing the hazelnut spread made with palm oil.

FIG. 8B is a photograph showing the hazelnut spread made with the microparticle formulation CGIP1.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

Aspects of the invention relate to microparticle compositions comprising a plurality of dietary fibers. In some embodiments, the microparticle compositions comprise at least two dietary fibers. Such microparticle compositions may be incorporated into food products. Particular applications of such microparticle compositions relate to the use as fat replacement in food products, for example by replacing some or all of the fat content such as oil with the microparticle compositions. Combining at least two dietary fibers to form the microparticles may result in a synergistic effect between the dietary fibers, resulting in microparticles with properties which may mimic fat in food. In particular, the microparticles of the present invention advantageously provide sensory effects such as texture and mouthfeel that fat content provides to food products.

“Dietary fibers” are polysaccharides that cannot be absorbed by humans or digested by enzymes in the human gastrointestinal tract. As used herein, “dietary fibers” include soluble and insoluble dietary fibers that are extracted or otherwise obtained from different sources, including plants, animals, microorganisms, and synthetic (e.g., chemically modified of natural polysaccharides).

Non-limiting examples of dietary fibers that may be used to make the microparticle compositions of the present invention include glucomannan (konjac glucomannan), psyllium husk, plant seed mucilage or gel (e.g., chia mucilage), inulin, cellulose, dextrins, lignin, chitins, pectins, beta-glucans, waxes, resistant starch, wheat dextrin, gums (e.g., gum Arabic, guar gum, locust bean gum, xanthan gum, gum karaya, gum tragacanth, etc.), carrageenan, agar, konjac flour, arabinoxylan, polymers of glucose (e.g., polydextrose), oligosaccharides (e.g., oligofructoses, galactooligosaccharides, fructo-oligosaccharides, etc.), and fibers derived from and/or obtain from vegetables or fruits or plants such as apple fibers, bamboo fibers, rice bran, rye bran, corn fibers, soy fibers, pea fibers, etc., including any other fibers extracted and/or obtained from any part of a plant including roots, stems, leaves, flowers, fruits, seeds, etc.

In some embodiments, the plurality of dietary fibers are selected based at least in part on the functional properties (e.g., the physico-chemical properties) of each of the dietary fibers.

In some embodiments, the plurality of dietary fibers are selected based at least in part on the nutritional functionality provided by each of the dietary fibers.

In some embodiments, each of the dietary fibers provide one or more of the desired functional properties (e.g., one or more of thickening and gelling, texturing, bulking, stabilizing, water binding, emulsification, dispersion, etc.) and/or nutritional properties (e.g., enhance or improve digestive health, bone health, cardiovascular health, etc., and control normal blood sugar levels, etc.) so as to produce a microparticle composition with the desired functional properties and/or nutritional properties for incorporation into a food product.

In some embodiments, the plurality of dietary fibers comprises a first dietary fiber and a second dietary fiber. The first dietary fiber may comprise one or more hydrocolloids. The second dietary fiber may comprise one or more viscous fibers.

“Hydrocolloids” or “hydrophilic colloids” are a heterogeneous group of long chain polymers (polysaccharides and proteins) that forms viscous dispersions when dispersed in water. Some hydrocolloids are also able to form gels when dispersed in water. Gel formation in hydrocolloids involves cross-linking of the polymer chains to form a three dimensional network that traps or immobilizes the water within it to form a rigid structure that is resistant to flow.

Non-limiting examples of hydrocolloids include plant seed mucilage or gel, xanthan, gums (e.g., guar gum, locust bean gum, gum karaya, gum tragacanth, and gum Arabic), alginate (e.g., sodium alginate, propylene glycol alginate, etc.), pectin (e.g., pectin high ester, etc.), carrageenan, gelatin, gellan, agar, cellulose and cellulose derivatives.

In some embodiments, the one or more hydrocolloids selected for use as the first dietary fiber possess one or both of the thickening and gelling properties.

In some example embodiments, the one or more hydrocolloids selected for use as the first dietary fiber comprise plant mucilage. In some example embodiments, the one or more hydrocolloids selected for use as the first dietary fiber consists essentially of plant mucilage. The mucilage may be extracted or otherwise obtained from any suitable plant parts such as rhizomes, roots, seeds, fruit, leaves, stems, and bark. In some non-limiting example embodiments, the mucilage extracted from chia seeds from the plant Salvia hispanica L.

In some embodiments, the concentration of the one or more hydrocolloids in the composition is in the range of from about 10 wt. % to about 75 wt. %, and in some embodiments, in the range of from about 15 wt. % to about 65 wt. %, and in some embodiments, in the range of from about 20 wt. % to about 40 wt. %.

“Viscous fibers” are soluble fibers that thicken when mixed with fluids to form a gel-like substance. A viscous fiber may be a hydrocolloid.

Non-limiting examples of viscous fibers that may be selected as the second dietary fiber include konjac glucomannan, beta-glucans, pectins, gums, psyllium husk, konjac flour, bran, any other suitable substances extracted or otherwise obtained from parts of plants, and suitable synthetic fibers.

In some embodiments, the concentration of the one or more viscous fibers in the composition is in the range of from about 20 wt. % to about 80 wt. %, and in some embodiments, in the range of from about 30 wt. % to about 70 wt. %, and in some embodiments, in the range of from about 35 wt. % to about 60 wt. %.

In some embodiments, at least one of the one or more viscous fibers selected as the second dietary fiber has a water holding capacity that is greater than the water holding capacity of at least one of the or more hydrocolloids selected as the first dietary fiber. Such viscous fiber may be referred to herein as a thickening agent. “Water holding capacity” may be defined as the maximum amount of water that can be absorbed and retained by the dietary fiber when an external force is applied.

In some example embodiments, the water holding capacity of the at least one viscous fiber is about 10% to about 90% greater than the water holding capacity of the at least one hydrocolloid, and in some embodiments, about 30% to about 90% greater, and in some embodiments, about 45% to about 90% greater.

In some example embodiments, the water holding capacity of at least one of the one or more viscous fiber is in the range of from about 10 g/g to about 200 g/g, and in some embodiments, in the range of from about 20 g/g to about 150 g/g, and in some embodiments, in the range of from about 30 g/g to about 150 g/g.

In some embodiments, at least one of the one or more viscous fibers selected as the second dietary fiber is a bulking agent.

“Bulking agents” or “bulk forming laxatives” are polysaccharides that may act to absorb water, thereby increases fecal mass. Bulking agents, when ingested, may result in an increase in the frequency of stool and/or soften the consistency of stool.

Non-limiting examples of bulking agents include psyllium husk, bran, methylcellulose, sterculia, dextrin, polycarbophil and the like.

In some embodiments, the one or more viscous fibers in the second dietary fiber comprises a first viscous fiber and a second viscous fiber. In such embodiments, at least two different types of viscous fibers are selected to form the second dietary fibers.

In some embodiments, the first viscous fiber comprises one or more thickening agents. In some example embodiments, the one or more thickening agents comprise konjac glucomannan.

In some embodiments, the concentration of the first viscous fiber in the composition is in the range of from about 20 wt. % to about 70 wt. %, and in some embodiments, in the range of from about 20 wt. % to about 60 wt. %, and in some embodiments, in the range of from about 20 wt. % to about 50 wt. %.

In some embodiments, the second viscous fiber comprises one or more bulking agents. In some example embodiments, the one or more bulking agents comprise psyllium husk.

In some embodiments, the concentration of the second viscous fiber in the composition is in the range of from about 0 wt. % to about 80 wt. %, and in some embodiments, in the range of from about 0 wt. % to about 40 wt. %, and in some embodiments, in the range of from about 0 wt. % to about 25 wt. %.

In some embodiments, the microparticle composition comprises a third dietary fiber. The third dietary fiber comprises one or more prebiotic fibers.

“Prebiotic fibers” may be defined as fibers that are selectively utilized by host microorganisms to confer a health benefit. Some known functional characteristics of prebiotics include the ability to: resist the low pH of the stomach, resist hydrolysis by mammalian enzymes, resist absorption in the upper gastrointestinal tract, the ability to be fermented by intestinal microbiota, and/or selectively stimulate the growth and/or activity of intestinal bacteria associated with host health and the overall well-being.

Some non-limiting examples of prebiotic fibers that may be selected for use as the third dietary fiber include oligosaccharides (e.g., fructans such as fructo-oligosaccharides, oligofructose, and inulin, and galactans). Prebiotic fibers may for example be extracted and/or otherwise be obtained from plants such as leeks, asparagus, onions, wheat, garlic, chicory, oats, soybeans, and Jerusalem artichokes.

In some embodiments, the one or more prebiotic fibers selected as the third dietary fiber are soluble in water. In some example embodiments, the water solubility of the one or more prebiotic fibers is at least 50 mg/mL at 25° C., and in some example embodiments, at least about 100 mg/mL at 25° C.

In some embodiments, the concentration of the one or more prebiotic fibers in the composition is in the range of from about 0 wt. % to about 90 wt. %, and in some embodiments, in the range of from about 0 wt. % to about 50 wt. %, and in some embodiments, in the range of from about 0 wt. % to about 30 wt. %.

In some example embodiments, the one or more prebiotic fibers selected for use as the third dietary fiber comprise inulin.

In some embodiments, the microparticle composition comprises two dietary fibers. In some embodiments, the two dietary fibers comprise at least a hydrocolloid and a viscous fiber. In some embodiments, the concentration of the hydrocolloid in the composition is between about 25 wt. % and about 60 wt. %, and the concentration of the viscous fiber in the composition is between about 40 wt. % and about 75 wt. %.

In some embodiments, the microparticle composition comprises at least three dietary fibers. In some embodiments, the at least three dietary fibers comprise at least a hydrocolloid and at least a mixture comprising two viscous fibers (e.g., a first viscous fiber and a second viscous fiber). In some embodiments, the concentration of the hydrocolloid in the composition is between about 30 wt. % and about 80 wt. %, the concentration of the first viscous fiber in the composition is between about 10 wt. % and about 40 wt. %, and the concentration of the second viscous fiber in the composition is between about 5 wt. % and about 30 wt. %.

In some embodiments, the microparticle composition comprises at least four dietary fibers. In some embodiments, the at least three dietary fibers comprise at least a hydrocolloid, at least a mixture comprising two viscous fibers (e.g., a first viscous fiber and a second viscous fiber), and at least a prebiotic fiber. In some embodiments, the concentration of the hydrocolloid in the composition is between about 10 wt. % and about 50 wt. %, the concentration of the first viscous fiber in the composition is between about 20 wt. % and about 60 wt. %, the concentration of the second viscous fiber in the composition is between about 2 wt. % and about 30 wt. %, and the concentration of the prebiotic fiber in the composition is between about 5 wt. % and about 40 wt. %.

In some example embodiments, the microparticle composition comprises four dietary fibers. The four dietary fibers comprise chia mucilage, glucomannan, psyllium husk and inulin.

In some embodiments, the composition further comprises one or more additives. The one or more additives may serve to modify one or more physical or chemical properties of the composition. For example, a viscosity modifier such as a surfactant may be mixed with the dietary fibers to increase the viscosity or flow of the composition. Other suitable additives for modifying the properties of the composition (including but not limited to the viscosity, solubility, swelling capacity, emulsification stability, water holding capacity, and/or oil holding capacity, etc.) may be added.

In some embodiments, the microparticle compositions of the present invention comprise properties (e.g., physicochemical properties) that are desirable for use as a replacement of some or substantially all of the fat content in food products. The microparticle compositions of the present invention have one or more of the following properties:
high viscosity (e.g., greater than about 10 Pa·s);
high solubility (e.g., greater than about 70%);
high swelling capacity (e.g., greater than about 40%);
high emulsification stability (e.g., greater than about 40%);
high water holding capacity (e.g., greater than about 10%);
high oil holding capacity (e.g., greater than about 2%); and/or
low particle size (e.g., average diameter of the particles being less than about 60 μm),
etc.

In some embodiments, the viscosity of the composition is between about 10 Pa·s and about 70 Pa·s, and in some embodiments, between about 20 Pa·s and about 60 Pa·s, and in some embodiments, between about 30 Pa·s and about 50 Pa·s. In some embodiments, the viscosity of the composition is greater than about 35 Pa·s.

In some embodiments, the solubility of the composition is between about 50% and about 99%, and in some embodiments, between about 70% and about 99%, and in some embodiments, between about 80% and about 99%. In some embodiments, the solubility of the composition is greater than about 85%.

In some embodiments, the swelling capacity of the composition is between about 50% and about 99%, and in some embodiments, between about 70% and about 99%, and in some embodiments, between about 80% and about 99%. In some embodiments, the swelling capacity of the composition is greater than about 80%.

In some embodiments, the emulsification stability of the composition is between about 30% and about 95%, and in some embodiments, between about 50% and about 90%, and in some embodiments, between about 60% and about 85%. In some embodiments, the emulsification stability of the composition is greater than about 75%.

In some embodiments, the water holding capacity of the composition is between about 5% and about 70%, and in some embodiments, between about 10% and about 60%, and in some embodiments, between about 20% and about 50%. In some embodiments, the water holding capacity of the composition is greater than about 25%.

In some embodiments, the oil holding capacity of the composition is between about 1% and about 50%, and in some embodiments, between about 5% and about 40%, and in some embodiments, between about 5% and about 30%. In some embodiments, the oil holding capacity of the composition is greater than about 10%.

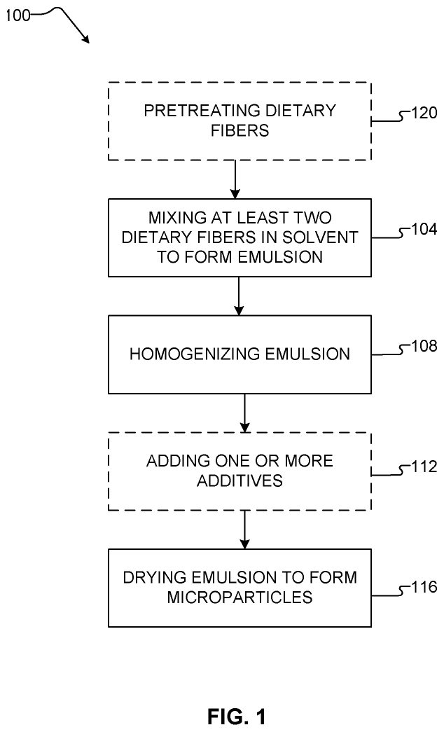

Aspects of the invention relate to methods of making a microparticle composition. Referring to FIG. 1, in some embodiments, the method 100 comprises mixing at least two dietary fibers in a solvent to form an emulsion (block 104). In some embodiments, the at least two dietary fibers comprises one or more hydrocolloids, and one or more viscous fibers. In some embodiments, the at least two dietary fibers further comprises one or more prebiotic fibers. Any suitable solvent may be used to combine the dietary fibers. In some embodiments, the solvent comprises water.

In some embodiments, the emulsion comprising the dietary fibers is homogenized (block 108). In some embodiments, one or more additives may be added to the emulsion before and/or during the homogenization (block 112). The one or more additives may be added to modify one or more physical or chemical properties of the composition.

The emulsion comprising the dietary fibers and optionally one or more additives may be dried to form microparticles (block 116). In some embodiments, microparticles with particle sizes of less than about 60 μm, or less than about 30 μm, or less than about 10 μm, are formed from the drying step 116.

In some embodiments, the drying step comprises spray-drying the emulsion to form microparticles. The spray-drying may be performed by feeding the emulsion into a dryer. Drying gas may be fed into the dryer. The contact of the emulsion with the drying gas dehydrates the emulsion. In some example embodiments, the dryer is maintained at a temperature in the range of from about 70° C. to about 120° C., and in some embodiments, in the range of from about 80° C. to about 110° C.

In some embodiments, the drying step comprises freeze-drying the emulsion. In some embodiments, the drying step comprises spray freeze drying.

Any other suitable drying methods may be used to dry the emulsion to form the microparticles, for example but not limited to drum drying, pulse-combustion drying, hot air drying, microwave drying, vacuum drying, microwave vacuum drying, etc.

In some embodiments, one or more of the dietary fibers are pretreated before mixing with a solvent to form an emulsion (block 120). In some embodiments, the pretreating comprises extracting the dietary fiber from a source. In some embodiments, the source comprises a seed.

In some example embodiments, the extracting comprises obtaining mucilage from a plant seed. In some embodiments, the extracting comprises solubilizing the seed by combining the seed with a solvent, such as water. The solubilizing may be performed using any suitable mixing methods including but not limited to stirring (e.g., magnetic stirring) and sonication (e.g., ultrasonication). The solubilizing maybe performed at a temperature in the range of from about 50° C. to about 120° C., and in some embodiments, from about 60° C. to about 100° C., and in some embodiments, from about 70° C. to about 90° C. In some example embodiments, the solubilizing is performed by stirring. The stirring may be performed at a rotational speed in the range of from about 200 rpm to about 1,500 rpm, or about 300 rpm to about 1000 rpm in some embodiments. In some example embodiments, the solubilizing is performed by ultrasonication. The sonication may be performed at a frequency in the range of from about 10 kHz to about 1,000 kHz, and in some embodiments, in the range of from about 20 kHz to about 500 kHz, and in some embodiments, in the range of from about 20 kHz to about 100 kHz.

In some embodiments, the extracting comprises separating the seed from the mucilage. The separating may be performed using any suitable separating methods, including but not limited to filtration and centrifugation.

In some embodiments, the extracting comprises dehydrating the separated mucilage. The dehydrating may be performed using any suitable drying methods, including but not limited to drum drying, pulse-combustion drying, hot air drying, microwave drying, vacuum drying, microwave vacuum drying, spray-freeze-drying and freeze-drying. In some example embodiments, the dehydrating of the separated mucilage comprises drying in a hot air oven at a temperature in the range of from about 30° C. to about 80° C., for about 5 to 20 hours. In some embodiments, the dehydrating step is omitted. In some embodiments, the separated mucilage is used directly. The separated mucilage may be mixed with the dietary fibers directly (i.e., without first being dehydrated), or used directly as a fat replacer.

Method 100 may be tuned to optimize one or more of the physical or chemical characteristics of the microparticle composition (e.g., yield, viscosity, solubility, swelling capacity, emulsification stability, water holding capacity, and/or oil holding capacity) and production efficiency by adjusting one or more of:
methods of drying the emulsion to form the microparticles;
operating conditions of the drying, e.g., temperature, pH, pressure, duration, etc.;
type(s) of dietary fibers;
concentration and/or weight proportion of the plurality of dietary fibers;
presence of additive(s);
methods used to obtain or extract dietary fibers from the source and operating conditions of such methods, e.g., temperature, pH, pressure, rotational speed or ultrasonic frequencies applied, duration, etc.;
etc.

Aspects of the invention relate to the use of the microparticle compositions of the present invention. In some embodiments, the microparticle compositions are used as fat replacement in food products. In such embodiments, the microparticle compositions possess at least some characteristics of fat when ingested. Some of those properties include creaminess, appearance, palatability, texture, and lubricity.

Some embodiments of the invention relate to using the microparticle compositions of the present invention to reduce the fat content in food products. In some embodiments, the microparticle compositions are used to reduce a total unsaturated fat in a food product by more than about 10%, and in some embodiments, by more than about 20%, and in some embodiments, more than about 40%, by replacing some or substantially all of the fat content in the food product. In some embodiments, the microparticle compositions are used to reduce a total saturated fat in a food product by more than about 30%, and in some embodiments, by more than about 50%, and in some embodiments, more than about 70%, by replacing some or substantially all of the fat content in the food product.

Some embodiments of the invention relate to using the microparticle compositions of the present invention to reduce calorie content in food products. In some embodiments, the microparticle compositions are used to decrease the total calorie content in a food product by more than about 50%, and in some embodiments, more than about 60%, and in some embodiments, more than about 70%, and in some embodiments, more than about 80%, by replacing some or substantially all of the fat content in the food product.

Some embodiments of the invention relate to using the microparticle compositions of the present invention to increase dietary fiber content in food products.

Some embodiments of the invention relate to using one or more nutritional compounds in the form of dietary fibers in the formulation of microparticle compositions for use in food products. In such embodiments, the dietary fibers are selected based on one or more of its nutritional properties and functional properties. The dietary fibers comprise the desired nutritional and/or health benefits, without adding other compounds, such as medicinal ingredients.

The microparticle compositions of the present invention may be incorporated or otherwise used in any suitable food products. Particular applications relate to incorporating the microparticle compositions in food products with high fat (e.g., oil) content.

The invention is further described with reference to the following specific examples, which are not meant to limit the invention, but rather to further illustrate it.

### EXAMPLES

Example microparticle compositions comprising two or more of a first dietary fiber (DF), a second dietary fiber (DF) and a third dietary fiber (DF) were prepared using the method 100 illustrated in FIG. 1. The first dietary fiber comprises a hydrocolloid. Chia mucilage (CM) was selected as the hydrocolloid. The second dietary fiber comprises a first viscous fiber and a second viscous fiber. Konjac glucomannan (KGM) was selected as the first viscous fiber, and psyllium husk (PH) was selected as the second viscous fiber. The third dietary fiber comprises a prebiotic fiber. Inulin (IN) was selected as the prebiotic fiber.

### Example 1

### Materials and Methods

### 1.1 Formulations

### 1.1.1 Preparation of Chia Mucilage (CM)

Chia seeds were obtained from Food to Live™ (New York, USA). CM was extracted from the chia seeds following three steps: 1) solubilization by ultrasonication (40 kHz, 1 hour, 80±5° C.), 2) separation by filtration, and 3) dehydration by a hot air oven (50° C., 10 hours).

TABLE 1
Tested treatment methods of extracting mucilage from chia seeds

| METHOD | SOLUBILIZATION | SEPARATION | DEHYDRATION |
|---|---|---|---|
| M1 | Magnetic Stirring | Centrifugation | Microwave vacuum |
| | 600 rpm, 2 h, | 1200 rpm, 50 min | dehydration |
| | 80 ± 5° C. | | 500 watts 45 seg |
| M2 | Magnetic Stirring | Filtration | Hot air oven |
| | 600 rpm, 2 hours, | | 50° C., 10 hours |
| | 80 ± 5° C. | | |
| M3 | Magnetic Stirring | Filtration | Microwave vacuum |
| | 600 rpm, 2 hours, | | dehydration |
| | 80 ± 5° C. | | 500 watts 45 seg |
| M4 | Magnetic Stirring | Centrifugation | Hot air oven |
| | 600 rpm, 2 hours, | 1200 rpm, 50 min | 50° C., 10 hours |
| | 80 ± 5° C. | | |
| M5 | Ultrasonication | Centrifugation | Microwave vacuum |
| | 40 kHz, 1 hour, | 1200 rpm, 50 min | dehydration |
| | 80 ± 5° C. | | 500 watts 45 seg |
| M6 | Ultrasonication | Centrifugation | Hot air oven |
| | 40 kHz, 1 hour, | 1200 rpm, 50 min | 50° C., 10 hours |
| | 80 ± 5° C. | | |
| M7 | Ultrasonication | Filtration | Microwave vacuum |
| | 40 kHz, 1 hour, | | dehydration |
| | 80 ± 5° C. | | 500 watts 45 seg |
| M8 | Ultrasonication | Filtration | Hot air oven |
| | 40 kHz, 1 hour, | | 50° C., 10 hours |
| | 80 ± 5° C. | | |

### 1.1.2 Other Dietary Fibers

IN and KGM were obtained from Puresource™ (Guelph, ON), and PH was obtained from Rootalive™ (Pickering, ON). All chemicals that were used were reagent grade and were generally obtained from Sigma Aldrich™ (St. Louis, MO, USA) and Thermo Fisher Scientific™ (Waltham, MA, USA).

### 1.1.3 Formulation Matrix

Solutions with CM, KG, PH, and IN were mixed in 400 mL Erlenmeyer™ flasks with a Polytron™ PCU-2-110 homogenizer (Brinkmann Instruments, Inc., Westbury, NY, USA) for three minutes. The tested formulations are listed n Table 2.

TABLE 2
Tested formulations to create microparticle compositions

| DF # | Type of fibers | Name | CM | KG | IN | PH |
|---|---|---|---|---|---|---|
| 2 | CM and IN | CI1 | 69.7 | — | 30.3 | — |
| | | CI2 | 13.8 | — | 86.2 | — |
| | | CI3 | 44.4 | — | 55.6 | — |
| | | CG1 | 35.6 | 64.5 | — | — |
| | CM and KG | CG2 | 45.4 | 54.6 | — | — |
| | | CG3 | 73.2 | 26.8 | — | — |
| | CM and PH | CP1 | 19.4 | — | — | 80.6 |
| | KG and IN | GI1 | — | 48.9 | 51 | — |
| 3 | CM, PH, and IN | CIP1 | 32.4 | — | 40.5 | 26.9 |
| | CM, KG, and IN | CGI1 | 20.1 | 36.4 | 43.5 | — |
| | | CGI2 | 28.9 | 34.8 | 36.3 | — |
| | | CGP1 | 46.1 | 46.2 | — | 7.6 |
| | CM, KG, and PH | CGP2 | 8.9 | 53.8 | — | 35.9 |
| | | CGP3 | 63.9 | 23 | — | 12.8 |
| | CM, KG, and IN | CGI1 | 20.1 | 36.4 | 43.5 | — |
| | | CGI2 | 28.9 | 34.8 | 36.3 | — |
| | | CGP1 | 46.1 | 46.2 | — | 7.6 |
| | CM, KG, and PH | CGP2 | 8.9 | 53.8 | — | 35.9 |
| | | CGP3 | 63.9 | 23 | — | 12.8 |
| 4 | CM, KG, IN and | CGIP1 | 35.3 | 42.2 | 15.3 | 7.1 |
| | PH | CGIP2 | 26.4 | 30.2 | 28.1 | 15.2 |

### 1.2 Spray-Drying Parameters

Solutions were dried with a Buchi™ B-290 Mini Spray Dryer (Buchi Labor Technik AG, Switzerland) at an inlet temperature of 90° C., an outlet temperature of 25° C., a gas flow rate of 4.1 L/min, and a feed rate of 2 mL/min.

### 1.3 Production Yield

The following equation (Eq. 1) was used to measure production yield:

$$Yield ( \% ) = \frac{Total amount of collected solids ( g )}{Total amount of initial solids in the spray drying solution ( g )} ) \times 100 \qquad Eq . 1$$

### 1.4 Dietary Fiber Sprayed Powder Characterization

### 1.4.1 Morphology

### 1.4.1.1 Size Distribution

A microscope was used to visualize micro-scale features. The morphology of spray-dried microparticles was visualized using a Scanning Electron Microscope (Hitachi™ S4700 SEM, Ultrahigh resolution SEM with field-emission gun) at 10 Kv and 8 mA. The powder positioned on an Isopore™ membrane filter (13 mm in diameter and 0.4 μm pore size) was placed on a SEM stub to prepare the samples for morphological analysis. Samples were sputter-coated with gold (8 nm layer) using a Cressington Sputter Coater™ to improve image quality.

The size distribution was determined by exploiting image analysis of spray-dried powder SEM pictures. The projected area equivalent diameter (da) of microparticles was determined by using ImageJ™. The analysis of high magnification images led to the observation of the surface micro-properties.

### 1.4.1.2 Distribution of Chemical Compounds

X-ray photoelectron spectroscopy analysis was accomplished using a Kratos Analytical Axis™ ULTRA spectrometer comprising a DLD spectrometer using a monochromatic aluminum source (AlKα, 1486.6 eV) operating at 150 W (10 mA emission current and 15 kV HT). The analysis of XPS on spray-dried microparticles is described as follows. Analysis was performed on a 700×300 μm² area of the sample. High-resolution scans were obtained at a 100 meV step size, pass energy of 20 eV, and averaged over 3 scans. Energy scale linearity was calibrated using Al, and Mg X-ray sources on Argon sputter cleaned gold and copper substrates. The calibration procedure was accomplished following the ISO 15472 international procedure.

### 1.4.1.3 Color

A LabScan™ XE spectrophotometer (Hunter Lab, U.S.A) was used to analyze the color of the microparticles. The equipment was calibrated using a standard black and white screen. The color measurement was obtained in terms of L*[dark (0-50) and light (50-100)], a*[green (negative numbers) and red (positive numbers)], and b*[blue (negative numbers) and yellow (positive numbers)].

### 1.4.1.4 Stability

Fourier transform infrared spectroscopy (FT-IR) was used to measure the stability of the spray-dried dietary fibers. A PerkinElmer™ Spectrum 100 FT-IR spectrometer was used with a frequency range of 4000-250 cm⁻¹.

### 1.4.2 Physicochemical Properties

### 1.4.2.1 Solubility and Swelling

Solubility and swelling were analyzed using a method described as follows. Samples (0.4 g) were mixed with 15 ml deionized water (DI) in 50 ml centrifuge tubes. The mixtures were stirred in a water bath at a temperature of 50° C. The samples were then centrifuged at 5000 g for 10 min. The supernatants were decanted into a pre-weighed aluminum container and were dried in an air oven at 105° C. overnight. The weight of the dried residues from the supernatant (m1) was measured by substracting the weight of empty aluminum weighing containers from the weight of the aluminum containers with the dried residue. The weight of the sediment (m2) was measured by dividing the difference between the weight of the tube with the sediment. The solubility index and swelling power were measured by Eq. 2 and Eq. 3 respectively.

$$Solubility ( \% ) = \frac{M 1}{Weight of dried sample} ) \times 100 \qquad Eq . 2$$

$$Swelling power ( \% ) = \frac{M 2}{Weight of dried sample \times ( 100 - solubility )} ) \times 100 \qquad Eq . 3$$

### 1.4.2.2 Viscosity

Viscosity was determined using a protocol described as follows. A 1% aqueous solution per each formulation was prepared and stirred for 35 minutes. The solution was measured on a Brookfield™ viscometer model LVF 100 (Brookfield Engineering Lab., Stoughton, MA) with spindle 1, 2, 3, 4 intervals at a rotational speed of 3 to 78 rpm at 25° C. and 30-second viscosity reading intervals.

### 1.4.2.3 Emulsion Stability

Emulsion stability (ES) was determined using a method described as follows. Suspensions of 1 g/100 g were homogenized using a Fisatom™ 7BD mechanical stirrer at 202.2 g for 2 minutes. An oil-in-water emulsion was prepared by adding 50 mL of soybean oil to the hydrated sample and mixing at 5055 g for 20 minutes. The emulsions were warmed up to 80° C. for 30 minutes, then cooled down to room temperature (25° C.) and centrifuged at 455 g for 20 minutes. The emulsion stability was measured using Eq. 4.

$$ES ( \% ) = \frac{V E S F}{VESI} \times 100 \qquad Eq . 4$$

where VESF is the final emulsion volume and VES/is the initial emulsion volume

### 1.4.2.4 Water and Oil Holding Capacity

Water- and oil-holding capacity (WHC and OHC) were determined following the methods described as follows. In the case of WHC, aqueous solutions, and in the case of OHC, canola oil solutions containing 4.5 mg/ml of sample were shaken for one hour in a shaking water bath (Ratek™ Instruments model SWB 20, Ratek™ Instruments Boronia) and centrifuged using Eppendorf™ 5810R (Eppendorf) at 2500×g for 30 minutes at 25° C. The liquid layer was removed, and the remaining was weighed.

### 1.4.2.5 Water Activity

The water activity (a_{w}) of spray-dried powders was measured using a water activity meter (Aqua Lab™ water activity meter) at 25° C.

### 1.5 Enhanced Hazelnut Cream Spread

### 1.5.1 Selection of the Optimal Formulation

Principal component analysis (PCA) was performed to determine the optimal formulation based on data obtained from yield, viscosity, solubility, swelling, water holding capacity, oil holding capacity, and emulsion stability. A value of 90% of the variance was used to enlighten the dataset. The number of components was determined by eigenvalues >1.

### 1.5.2 Production

The products required for preparing hazelnut cream spread are hazelnut (Food to live Delicious & Healthy™, Brooklyn, NY), palm oil (Okonatur™, Miami, Fl), natural cocoa (Hershey's™ Missisauga, ON), pure vanilla extract (Suchiate™, Tlaxcala, Mexico), soy lecithin (Texturestar™, Etobicoke, ON), non-fat fortified milk (Milkylicious™, Minh, Vietnam), and icing sugar (Lantic/Rogers™, British Columbia). Microparticles produced with the optimal formulation were used.

Spreads were formulated to warrant close resemblance to real commercial products. All formulas used for hazelnut butter are listed in Table 3. Palm oil (in the control formula) was replaced with microparticles of the selected formulation at different concentrations. Hazelnuts were roasted for 20 min at 300° C. The roasted hazelnuts were grinded using a Ninja™ Professional Food Processor until a butter texture was obtained. Palm oil, soy lecithin, cocoa, and hazelnut were added. Fat-free milk, microparticles, powdered sugar, and vanilla were prepared in another vessel. Both mixtures were combined.

Three formulations were selected. Table 3 lists the three different formulations and the control used for testing the selected microparticles as a fat replacer.

TABLE 3
Control and three formulations of different hazelnut spread creams

| Ingredient | Control | Fat-free | Low-fat | Reduced fat |
|---|---|---|---|---|
| Sugar | 34.1 | 34.1 | 34.1 | 34.1 |
| Hazelnut | 31.6 | 31.6 | 31.6 | 31.6 |
| Fat replacer | 0.0 | 14.0 | 7.0 | 4.5 |
| Fat free milk | 12.4 | 12.4 | 12.4 | 12.4 |
| Cocoa | 5.6 | 5.6 | 5.6 | 5.6 |
| Soy lecithin | 1.2 | 1.2 | 1.2 | 1.2 |
| Vanilla | 1.1 | 1.1 | 1.1 | 1.1 |
| Palm oil | 14.0 | 0.0 | 7.0 | 9.5 |

### 1.5.3 Caloric Content Calculation

The proximate composition of the spreads was measured in triplicate following the official methods of the AOAC: Protein (981.10), fat (983.23), moisture (950.46), ash (920.153), and total dietary fiber (985.29). Caloric value was obtained based on 9 kcal/g for fat, 4 kcal/g of protein and carbohydrate, and 2 kcal/g for dietary fiber. The carbohydrate content was calculated by the difference (100-[sum of lipid+protein+moisture+ash]).

### 1.5.4 Sensory Analysis

Triangle test was done to determine if there was a perceptible difference between the samples. Details are summarized in Table 4. For paired comparison test, the attributes analyzed were a chocolate flavor, color, creamy texture, creamy appearance, spreadability, and brightness. In paired preference test, panelists were asked to indicate their preference for one sample. Blind codes with three digits were used. Thirty (30) g of spread sample was served at room temperature. The number of correct judgments was counted, and the significance was determined by using a minimum number of correct responses, as shown in Table 4. A quantitative descriptive analysis was also performed using 11 trained panelists. Samples were coded with a random three-digit code and served in a randomized order. Each attribute was rated on a 10-point scale, where 0 represents none and 10 represents very strong. The source of variation was analyzed using three way-ANOVA and Spider Web. Sample A represented the control formulation for all sensory tests, while sample B represented a fat-free formulation.

TABLE 4
Experimental design of the sensory analysis

| | | Paired preference and |
|---|---|---|
| Description | Triangle test | comparison test |
| Total test | 66 | 67 |
| Product arrangement | AAB.BBA, BAB.BBA, | AB BA |
| | ABA, BAA | |
| Significance level | 0.05 | 0.05 |
| Error type b & a | 0.05 | 0.05 |
| probability | | |
| Accept Ho if | ≤29 correct judgments | ≤42 correct judgments |
| pD | 30% | 30% |
| Ho | The is no significant | The is no significant |
| | difference between the | difference between the |
| | samples | samples for the |
| | | attribute evaluated the |
| | | sample. |
| Ha | There is a significant | There is a significant |
| | difference between the | difference in the |
| | samples | attribute evaluated |
| | | between the samples |

### 1.6 Statistical Approach

Triplicates were performed for all analyses. Mean and standard deviation were calculated. One-way analysis of variance (ANOVA) was used to validate the relationship between total weight percentage and yield, and microparticles' size. Principal component analysis was designed using Minitab™ 19 to recognize a lesser number of correlated variables for choosing the microparticles to be used as a fat replacer. A loading plot was computed in Minitab Statistical Software™ for the first two principal components and was used to identify clusters, trends, and outliers within the data.

### Results

### 1.1 Chia Mucilage Extraction

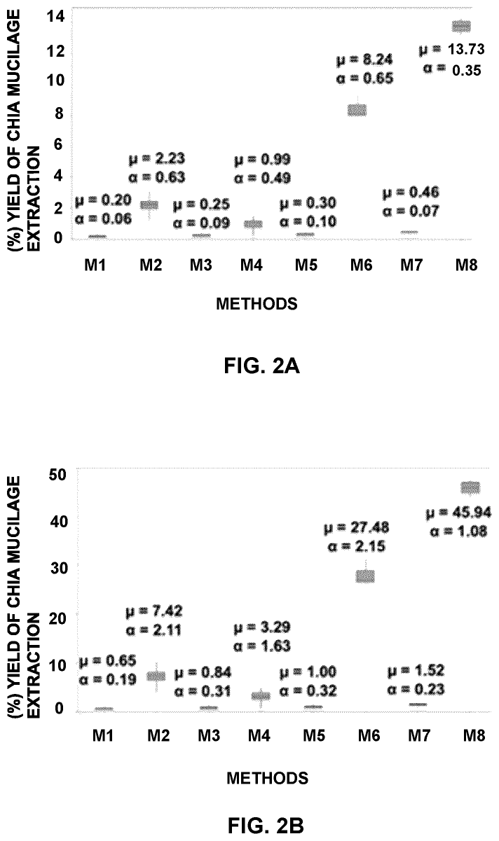

Eight different methods of extracting mucilage from chia seeds were tested as previously discussed herein at section 1.1.1. FIGS. 2A and 2B are plots showing the yield as the dry weight of the extracted mucilage relative to the weight of the seed using the eight different extraction methods. FIG. 2A is a plot showing the yield as the dry weight of the extracted mucilage relative to the weight of the seed. FIG. 2B is a plot showing the yield as the dry weight of the mucilage relative to the maximum mucilage which can be obtained.

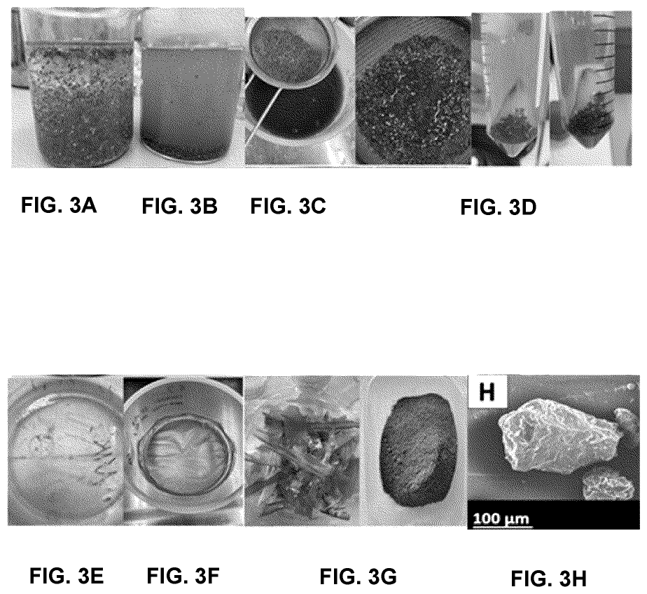

Referring to FIG. 2A, the yield was meaningfully higher (p<0.05) when method 8 (M8) was used. When M8 was used to extract mucilage from chia seeds, a yield of 45.94% relative to mucilage and 13.78% relative to the seed weight was achieved. FIGS. 3A and 3B are photographs of the chia seeds mixture when the mixture was solubilized by magnetic stirring and ultrasonication, respectively. FIGS. 3C and 3D are photographs of the chia seeds mixture when the mucilage was separated by filtration using a mesh and centrifugation, respectively. FIGS. 3E and 3F are photographs of the separated mucilage when the mucilage was dehydrated by microwave vacuum dehydration and hot air oven, respectively. FIG. 3G is a photograph of the final mucilage.

The FIGS. 3A to 3G photographs support that the chia seeds show better hydration when ultrasonication is used. This technique may enhance the processing time and reduce chemical hazards for extraction. Ultrasonication may surge the separation of mucilage from the seed by ameliorating its solubility in water. The results achieved using M8 and others are shown in FIGS. 2A and 2B. The yield achieved with M8 is significantly greater as compared to the other methods.

The mucilage achieved using extraction method M8 was analyzed under a Scanning Electron Microscope. FIG. 3H is an SEM image of the mucilage that was extracted by M8 at 100 μm. The porous structure of chia mucilage could be caused by the CM's rheological properties.

### 1.2 Production Yield

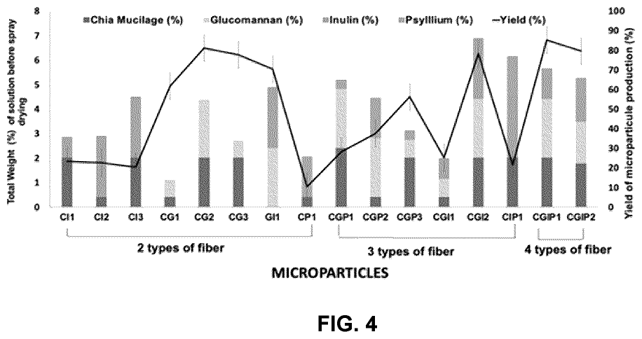

In spray drying, the yield depends on the spraying conditions and the material properties. FIG. 4 is a plot showing the total weight of the emulsions containing the dietary fibers before spray drying against the different microparticle formulations shown in Table 2. The Table 2 formulations are divided into three groups depending on the number of dietary fibers contained in the microparticles.

### 1.3 Dietary Fiber Sprayed Powder Characterization

### 1.3.1 Morphology

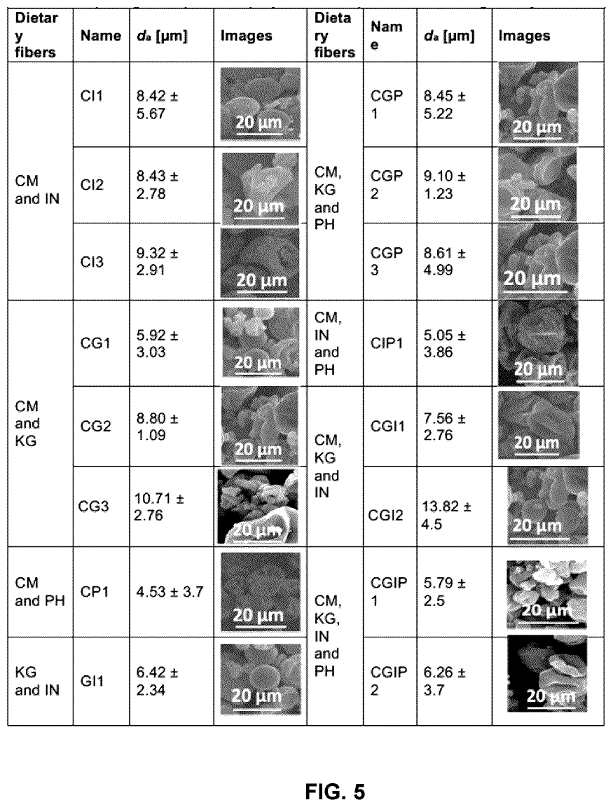

There can be several morphological aspects of spray-dried microparticles, including the diameter, surface appearance, the distribution of chemical compounds on the surface, and color. The appearance and the da of the microparticles for each of the formulations listed in Table 2 are shown in FIG. 5.

The distribution of the dietary fibers within the spray-dried microparticles was analyzed using an XPS. XPS allows the detection of chemical elements at a specific penetration from the particles' surface. 10 nm was selected as the penetration depth. Table 5 lists the chemical elements that are distributed at the surface of the tested spray-dried microparticles. This analysis helps to determine which of the components have been encapsulated, thereby are absent from the surface after spray drying.

TABLE 5
Distribution of chemical elements of microparticles at 10 nm

| | | Chemical elements at the surface | | | | | | Color | | |
|---|---|---|---|---|---|---|---|---|---|---|
| Number | Sample | Ca2s | N1s | K2s | P2p | Mg2s | S2p | L | a | b |
| Pure DF | IN | | | | | | | 73.40 | −0.40 | 4.70 |
| | CM | 7.01 | 70.5 | — | 15.0 | 7.8 | — | 27.90 | 4.18 | 12.81 |
| | KG | — | 88.0 | — | 6.3 | — | 5.7 | 68.63 | 1.08 | 6.24 |
| | PH | 11.7 | 66.0 | 16 | 6.4 | — | — | 65.68 | 2.11 | 11.14 |
| 2 | CI1 | — | 96.5 | — | 3.5 | — | — | 59.68 | 1.83 | 14.81 |
| | CI2 | — | 95.5 | — | 4.3 | — | — | 63.98 | 1.35 | 10.35 |
| | CI3 | — | 97.5 | — | 2.5 | — | — | 40.74 | 2.88 | 14.16 |
| | CG1 | — | 93.3 | — | 2.6 | — | 4 | 62.25 | 1.25 | 11.57 |
| | CG2 | — | 94.7 | — | — | — | 5.7 | 62.64 | 2.28 | 14.52 |
| | CG3 | — | 89.5 | — | 2.0 | — | 8.4 | 57.91 | 1.9 | 12.39 |
| | CP1 | — | 100 | — | — | — | — | 48.29 | 3.16 | 15.46 |
| | GI1 | 0.7 | 94.5 | — | 2.8 | — | 2 | 38.22 | 3.23 | 13.03 |
| 3 | CGP1 | 4.9 | 78.7 | 10.5 | 1.0 | — | 4.8 | 53.49 | 1.72 | 13.25 |
| | CGP2 | 3.0 | 74.6 | 8.06 | 4.2 | 3.3 | 6.7 | 65.06 | 1.88 | 12.94 |
| | CGP3 | 3.4 | 80.3 | 9.65 | 0.7 | — | 5.9 | 58.23 | 1.96 | 14.16 |
| | CIP1 | 1.3 | 80.8 | — | 1.3 | 9.3 | 7.2 | 48.29 | 3.17 | 15.23 |
| | CGI1 | — | 89.5 | — | 3.9 | — | 6.1 | 60.49 | 2.09 | 12.89 |
| | CGI2 | — | 88.8 | — | 4.6 | — | 6.6 | 48.22 | 1.23 | 12.65 |
| 4 | CGIP1 | 4.9 | 78.6 | 10.4 | 1.2 | — | 4.8 | 36.03 | 4.46 | 15.76 |
| | CGIP2 | 80.6 | — | 9.61 | 4.0 | — | 5.7 | 67.08 | 1.51 | 12.28 |

### 1.3.2 Stability

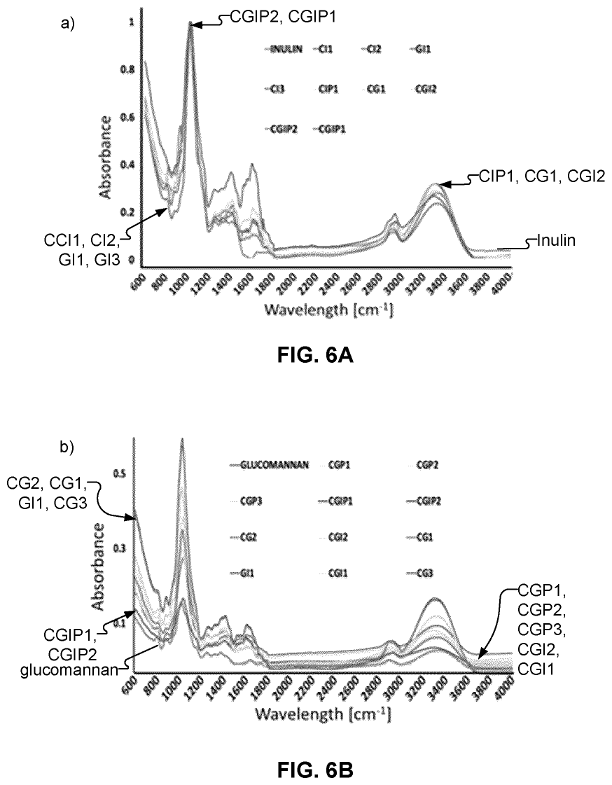

The stability of DF indicates if the spray drying process affected the chemical structure of the microparticles in any material manner. FTIR was used to qualitatively to verify if any significant change in the vibrational modes of the DF selected occurred. FIGS. 6A-D are IR spectra of the spray-dried microparticles as compared to pure DF, IN in FIG. 6A, KGM in FIG. 6B, PH in FIG. 6C, and CM in FIG. 6D.

### 1.3.3 Physicochemical Properties

The main physicochemical properties of spray-dried microparticles containing DF are summarized in Table 6. These properties include solubility, swelling, emulsion stability, water activity, viscosity, water holding capacity (WHC), and oil holding capacity (OHC).

TABLE 6
The physiochemical properties of the tested spray-dried microparticles.

| DF | | Solubility | Swelling | | | | | |
|---|---|---|---|---|---|---|---|---|
| # | Sample | (%) | (%) | ES (%) | A_{w} | Viscosity | WHC | OHC |
| 2 | CI1 | 80 ± 1.2 | 72 ± 1.2 | 60 ± 3.5 | 0.3 ± 0.2 | 10.45 | 21.09 | 7.25 |
| | CI2 | 78 ± 2.8 | 52 ± 3.4 | 17 ± 2.2 | 0.3 ± 0.1 | 2.07 | 6.59 | 2.22 |
| | CI3 | 87 ± 4.5 | 64 ± 2.3 | 41 ± 1.9 | 0.3 ± 0.1 | 6.66 | 14.54 | 4.98 |
| | CG1 | 78 ± 3.3 | 89 ± 2.7 | 89 ± 0.3 | 0.3 ± 0.3 | 51.83 | 35.75 | 15.05 |
| | CG2 | 82 ± 0.8 | 90 ± 2.7 | 88 ± 1.8 | 0.3 ± 0.1 | 46.33 | 34.99 | 14.36 |
| | CG3 | 76 ± 1.4 | 89 ± 0.9 | 86 ± 2.5 | 0.3 ± 0.2 | 30.36 | 31.86 | 12.10 |
| | CP1 | 80 ± 5.2 | 45 ± 2.3 | 56 ± 2.3 | 0.3 ± 0.2 | 39.10 | 33.03 | 28.53 |
| | GI1 | 87 ± 1.9 | 76 ± 0.3 | 49 ± 1.3 | 0.3 ± 0.4 | 34.76 | 21.12 | 9.31 |
| 3 | CIP1 | 87 ± 2.8 | 76 ± 3.8 | 76 ± 4.9 | 0.3 ± 0.1 | 20.71 | 19.46 | 12.21 |
| | CGI1 | 90 ± 0.7 | 87 ± 2.3 | 53 ± 2.6 | 0.3 ± 0.4 | 29.61 | 21.71 | 8.99 |
| | CGI2 | 95 ± 2.3 | 89 ± 3.1 | 59 ± 2.3 | 0.3 ± 0.2 | 29.74 | 23.41 | 9.51 |
| | CGP1 | 87 ± 4.1 | 92 ± 0.3 | 45 ± 0.8 | 0.3 ± 0.3 | 11.61 | 16.00 | 15.45 |
| | CGP2 | 80 ± 0.4 | 95 ± 1.3 | 39 ± 3.4 | 0.3 ± 0.5 | 23.23 | 14.80 | 22.42 |
| | CGP3 | 94 ± 1.0 | 94 ± 2.2 | 64 ± 2.1 | 0.3 ± 0.2 | 17.38 | 22.88 | 14.78 |
| 4 | CGIP1 | 85 ± 1.3 | 82 ± 2.8 | 76 ± 1.2 | 0.3 ± 0.3 | 40.49 | 30.01 | 13.62 |
| | CGIP2 | 85 ± 0.8 | 80 ± 3.5 | 73 ± 2.2 | 0.3 ± 0.4 | 38.94 | 29.71 | 12.15 |

### 1.4 Enhanced Hazelnut Cream Spread

### 1.4.1 Selection of the Optimal Formulation

Table 7 shows the correlation between the PCA components, and the variables selected for determining the optimal formulation. Seven components are shown in Table 7; however, the inventors considered the most important components to be the first three. The first component clarifies 62.7% of the variance, followed by a second component with 18.5% and the third component with 10.7% obtained in the seven variables. Thus, the cumulative proportion of the first three components reached 92%.

TABLE 7
Correlation between variables and factors.

| Variable | PC1 | PC2 | PC3 | PC4 | PC5 | PC6 | PC7 |
|---|---|---|---|---|---|---|---|
| Yield (%) | 0.37 | 0.03 | 0.35 | −0.59 | 0.08 | 0.02 | −0.01 |
| Solubility | 0.11 | 0.69 | 0.40 | −0.10 | 0.16 | 0.00 | 0.00 |
| Viscosity | 0.45 | 0.01 | 0.20 | −0.04 | −0.53 | −0.62 | −0.27 |
| Swelling | −0.29 | −0.23 | 0.18 | 0.05 | −0.45 | 0.73 | 0.07 |
| Emulsion Stability | −0.14 | −0.18 | 0.01 | 0.332 | 0.55 | 0.09 | −0.60 |
| Water Holding | −0.26 | −0.02 | 0.03 | 0.29 | 0.27 | −0.22 | 0.74 |
| Capacity | | | | | | | |
| Oil Holding | −0.37 | −0.19 | −0.20 | −0.66 | 0.30 | 0.02 | 0.06 |
| Capacity | | | | | | | |

### 1.4.2 Caloric Content Calculation

One of the objectives of Example 1 was to develop low-fat products along with an increase in DF content. Table 8 shows the nutritional differences between the control, made as a traditional hazelnut spread with palm oil, and the product containing the microparticles with optimal properties. Table 8 shows the nutritional differences between the control, made as a traditional hazelnut spread with palm oil, and the product containing the microparticles with optimal properties.

TABLE 8
Proximate analysis of the hazelnut spread with palm oil (control)
and hazelnut spread with the tested microparticles.

| | Hazelnut spread | Hazelnut spread |
|---|---|---|
| Nutrient | with palm oil | with microparticles |
| Fibre, total dietary | 5.10 ± 0.87 | 8.95 ± 0.23 |
| Fat, total | 34 ± 1.88 | 19.88 ± 0.57 |
| Saturated fat | 9.43 ± 0.78 | 2.13 ± 0.25 |
| Polyunsaturated fat | 5.78 ± 1.77 | 3.36 ± 1.69 |
| Monounsaturated fat | 20.37 ± 0.89 | 14.82 ± 0.86 |
| Trans fat | 0.00 ± 0.00 | 0.00 ± 0.00 |
| Cholesterol | 0.00 ± 0.00 | 0.00 ± 0.00 |
| Carbohydrates, total | 43 ± 0.99 | 49.56 ± 0.72 |
| Sodium | 9.12 ± 0.97 | 8.78 ± 1.98 |
| Sugars | 36.23 ± 0.80 | 35.60 ± 1.77 |
| Added sugars | 34.09 ± 0.21 | 33.72 ± 0.56 |
| Protein | 6.45 ± 1.09 | 5.91 ± 1.56 |
| Energy (kCal) | 481.4 ± 0.98 | 353 ± 1.78 |

### 1.4.3 Sensory Analysis

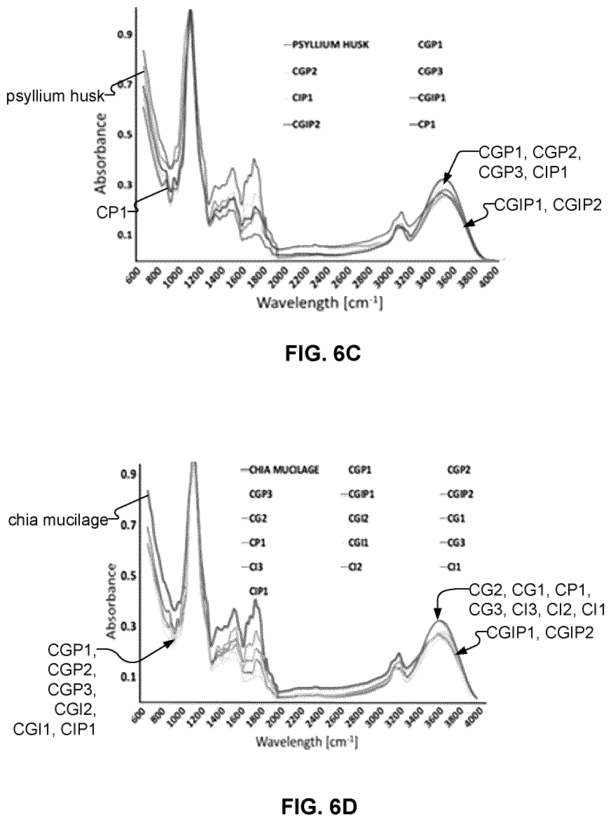

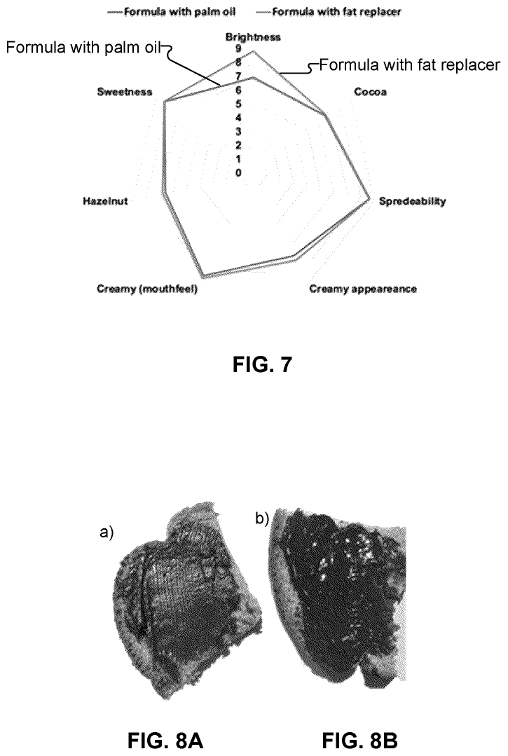

The first step in the sensory analysis was achieved using a triangle test. Here, for a total test of 66, the corrected judgments obtained were 56. This indicates a significant difference (P≤0.05) between the sample of hazelnut cream produced with palm oil and the sample of hazelnut cream containing spray-dried microparticles. Additionally, in the paired preference test, 73.13% of panelists preferred the hazelnut spread cream containing spray-dried microparticles over the control (i.e., hazelnut spread cream that was made with palm oil). The preference test included 67 tests, and 49 correct judgments were obtained. In the paired comparison test, another important result relates to the difference in brightness. Panelists found a significant difference for this attribute (p<0.05). However, a significant difference was not found between the two samples for the attributes of color, cocoa flavor, spreadability, creamy texture, creamy appearance (mouthfeel), and hazelnut flavor. These results showed that panelists (p<0.05) were not able to tell if there was a difference between the two samples for these attributes. With regards to the descriptive analysis (QDA), the intensity of the sensory attributes was determined. A summary of the results is presented in FIGS. 7 and FIGS. 8A and 8B.

### Discussion of Results

### 2.1 Production Yield and Microparticle Size.

The production yield in conventional spray drying methods varies between 50 to 90% depending on the spraying conditions and formulations. A much broader range of yield in the range of from 10.22 to 83.45% was achieved in this Example. The lowest yields are obtained for the more viscous conditions. PH, for instance, has one of the highest viscosities, 61 Pas, and it can stick to the spraying chamber on the surface, resulting in low yields. Mucilage is the least viscous material. Mucilage does not typically stick on the surface of the spraying chamber, thereby the highest yields can be obtained. This indicates the importance of microencapsulation (see e.g., Table 5). The characterization of spray-dried microparticles correlates with the behavior when they are added to different types of food and when the food is digested. Results of this Experiment support that neither the morphology nor the size of spray-dried microparticles composed of different DF show any major differences in particle size. The average dₐ is about 6.5 μm, and all of the tested microparticles show a hollow shape. The inventors believe that this type of shape is favorable for higher water dispersibility and homogeneity when added to aqueous formulations. The hollow structure may be due to the low ratio between water and component, which could lead to an early shell formation. Therefore, water may be forced to leave through the shell's pores producing hollow particles. The inventors believe that the lack of differences in morphology may also be due to the slight differences in chemical properties between the DF selected. For instance, the molecular weight of the selected four DF varies at most, on average, 50 Da. The inventors believe that such difference is minor and does not affect the particle formation process. The minor difference in the morphology of the different spray-dried microparticle compositions may be due to the differences in ratios between DF. The inventors believe that based on the size dimensions, all of the tested formulations may be used as fat replacement in food products.

### 2.2 Microparticle Characterization

The results of this Experiment show that the quantity of DF contained in spray-dried microparticles did not affect their stability. Referring to FIGS. 6A to 6D, the differences in peak center and area were not recognizable in the IR spectra for pure DF or the tested spray-dried DF. For example, the presence of the typical 3410 cm⁻¹ wavelength indicates the stretching vibrations of O—H and is present in all of the IN-containing microparticles. The wide peak of KGM of O—H (between 3000 and 3700 cm⁻¹) is maintained after the spraying procedure. The saccharide bands (C═O stretching) are present with strong intensity at 10¹⁵ cm⁻¹ for all the DFs; however, the higher intensities can be seen for IN and microparticles containing IN. The band at 1600-1700 cm⁻¹ present in the IR spectrum of CM may be accredited to the aromatic group from glucuronic acid, while bands at 3400 cm⁻¹ to the —OH stretching of the hydroxyl groups, and bands at 2900 cm⁻¹ to aliphatic-C—H stretching vibration. The spectra support that all of the peaks are unmodified for spray-dried microparticles.

The inventors believe that another important morphological aspect of spray-dried DF microparticles for fat replacers is the distribution of chemical components on the surface of the microparticles. The elements that are present on the microparticle surface may dictate the behavior in solutions and dispersions as well as important powder properties, such as viscosity or adhesion forces. In the tested spray-dried DF microparticles, the chemical compounds on the surface are the ones with the highest molecular weights. Referring to Table 5, KGM, having the highest molecular weight of 2000-6000 kDa, was detected in most of the spray-dried microparticles. However, other DF was also found on the surface of some tested microparticles due to other characteristics, such as viscosity. The inventors believe that highly viscous solutions tend to show an earlier shell formation time with respect to more liquid-like solutions; as such neither the surface chemical composition may be a good indicator for the selection of an optimal fat replacer. Similarly, the inventors believe that the strong variability of the color distribution in the powder suggest that color may not be used as a variable for selecting an optimal powder. However, color is essential in food additives. For example, if the objective were to produce hazelnut chocolate cream, the accepted colors may be brown, white, or any dark tones, as found in every powder developed in this Experiment, as shown in Table 5.

### 4.3 Microparticle Physiochemical Properties.

The inventors believe that physicochemical properties, such as yield (%), viscosity, and solubility, are the main variables in choosing microparticles for fat replacement. These characteristics may be associated with sensory attributes. High solubility may be an important characteristic for a fat replacer. If the final food products contain agglomerates or lumps, the human perception can be drastically affected. The solubility of DF may be defined by the inter and intrachain connections rather than the nature of monosaccharides units. Spray drying may be used to further enhance solubility. The inventors believe that when particles have small sizes, the disjoining pressure is greater than those of larger particles, causing a thinner diffusion later and growing surface area. Referring to Table 6, spray drying enhanced the solubility of the composition significantly (p<0.05). The results shown in Table 6 suggest that high contents of DFs do not impact the solubility (p<0.05). The results show that the only DF which appears to impact the solubility the composition is IN. In particular, the tested formulations with the highest contents of IN are more soluble. PH appears to show the opposite of IN. High arabinose, galactose, glucose, arabinose, and xylose contents (which are neutral polysaccharides with low solubility in water) may contribute to the low solubility of the PH-containing microparticles.

The highest swelling capacity was observed in microparticles labeled CGP2, CGP3, and CGP1, with values of 95, 94, and 92%, respectively. The inventors believed that a reason for the high swelling capacity may be the presence of KGM. A possible mechanism may be that hydrogen bonds found in the carbohydrate allow water access to the OH groups in the structure. The inventors believe that viscosity is highly correlated with mouthfeel once the fat is reduced. Viscosity is related to the capacity to absorb water and forms a gelatinous mass from the physical interactions between polysaccharide molecules in solution. The highest viscosity value was observed in the CP1 formulation, which was determined to be 39.10 Pa·s. This formulation includes only PH and CM, which have viscosity values of 61.00 and 15.00 Pa·s, respectively.

ES is a measure of the ability of emulsions to withstand modifications in their physicochemical properties over time. When emulsions are unstable, the quality of the products may be jeopardized. The inventors believe that the most influential parameter on the ES is the type of DF. The highest ES was observed at 89%, which was found in the formulation containing KGM and PH.

WHC refers to the ability of food to hold water when a force, pressure, centrifugation, or heat is applied. Firmness, opaqueness, and acceptability are strictly related to the WHC. The highest WHC was found in all KGM-containing microparticles. OHC has a very similar trend and meaning as WHC. A high OHC may also give fibers the ability to emulsify and stabilize high-fat food products, and it refers to physical structure rather than to oil affinity. The formulation with the highest OHC was CP1, with a measured value of 28.33 g/g. The inventors believed that the size of the microparticles may impact OHC. CP1 has an average dₐ of 8.34 μm, which is one of the highest among the tested formulations. The larger size of the CP1 formulation may be due to a larger quantity of DF in the microparticles, in particular CM and PH. CM and PH were extracted from seeds. CM and PH contain a high protein content in their structure. The inventors believe that the combination of proteins and carbohydrates may explain the covalent bond with the proteins in the seed, which may produce a hydrophobic group bound to the oil droplet, thereby resulting in greater oil retention being observed. The yield, viscosity, solubility, swelling, water holding capacity, oil holding capacity, and emulsion stability were used in the PCA analysis to select the microparticles with the highest potential to serve as fat replacers.

### 4.4 Microparticle Application in Hazelnut Spread as a Fat Replacer and Sensory Analysis

Referring to FIG. 4 and Table 6, the PCA analysis determined that microparticle CGIP1 with a yield of 83.45%, solubility of 84.63%, and viscosity of 40.49 Pa·s was selected as the composition for use to conduct further experiments by replacing the fat in hazelnut spread with the CGIP1 microparticles. The hazelnut spread containing the microparticles showed a significant (P<0.05) drop in total fat content from 34% to 20% (41% reduction), as shown in Table 8. The amount of saturated fat diminished (P<0.05) from 9% to 2% (77% reduction). An increase from 5% to 9% of dietary fiber (i.e., about 80% increase), and a drop of 26% in calories were achieved with the hazelnut spread containing microparticles. Other components, such as sodium, sugar, and carbohydrates, remained the same, as shown in

### Table 8.

The inventors also compared the hazelnut spread with palm oil (control) and with the tested spray-dried microparticles by sensory mouth feelings studies. The results of the triangle test show that the difference between the samples is significant. In particular, 84.84% of the panelists identified a perceptible difference between the control hazelnut with palm oil sample, and the hazelnut spread containing microparticles sample. In addition, based on the paired preference test, most of the panelists (73.13%) reported that sample B (hazelnut spread with microparticles) was preferred over sample A (hazelnut spread with palm oil). In a paired comparison test, no significant difference was found in the color, cocoa flavor, spreadability, creamy texture, creamy appearance (mouthfeel), and hazelnut flavor between the two samples, as illustrated in FIG. 7. The inventors believe that this could be due to the fact that cocoa and hazelnut content (%) were not altered in both formulations, and thus the flavor was not affected. The results also support that the inclusion of DFs as fat replacers where the DFs have high viscosity produces the same creaminess between the two spreads. The two samples may differ only by their brightness (p<0.05).

Results of this Experiment support the use of microparticles comprising a plurality of dietary fibers as an additive and fat replacer, while providing nutritional benefits. Result show that the microparticles can mimic the functional and sensory properties of fat.

### REFERENCES

The following documents describe related technologies. Embodiments of the present technology may incorporate features as described in these references. All of the following references are hereby incorporated herein by reference as if fully set forth herein for all purposes.
1. Wolfram, G., Dietary fatty acids and coronary heart disease. European Journal of Medical Research 2003, 8 (8), 321-324.
2. Singh, A.; Pratap Singh, A.; Ramaswamy, H. S., A controlled agitation process for improving quality of canned green beans during agitation thermal processing. Journal of Food Science 2016, 81 (6), E1399-E1411.
3. Leitner, V. M.; Guggi, D.; Krauland, A. H.; Bernkop-Schnürch, A., Nasal delivery of human growth hormone: in vitro and in vivo evaluation of a thiomer/glutathione microparticulate delivery system. Journal of Controlled Release 2004, 100 (1), 87-95.
4. Leiva Arrieta, A. Double (iron and zinc) fortified black tea: assessing the bioaccessibility and bioavailability using spray drying microencapsulation technology. University of British Columbia, Vancouver 2020.
5. Cotton, J. R.; Burley, V. J.; Weststrate, J. A.; Blundell, J. E., Fat substitution and food intake: effect of replacing fat with sucrose polyester at lunch or evening meals. British Journal of Nutrition 1996, 75 (4), 545-556.
6. Mikkelsen, P. B.; Toubro, S.; Astrup, A., Effect of fat-reduced diets on 24-h energy expenditure: comparisons between animal protein, vegetable protein, and carbohydrate. The American Journal of Clinical Nutrition 2000, 72 (5), 1135-1141.
7. Sandrou, D.; Arvanitoyannis, I., Low-fat/calorie foods: current state and perspectives. Critical Reviews in Food Science and Nutrition 2000, 40 (5), 427-447.
8. Scheuer, P. M.; Mattioni, B.; Barreto, P. L. M.; Montenegro, F. M.; Gomes-Ruffi, C. R.; Biondi, S.; Kilpp, M.; Francisco, A. d., Effects of fat replacement on properties of whole wheat bread. Brazilian Journal of Pharmaceutical Sciences 2014, 50, 703-712.
9. Sahan, N.; Yasar, K.; Hayaloglu, A., Physical, chemical and flavour quality of non-fat yogurt as affected by a β-glucan hydrocolloidal composite during storage. Food Hydrocolloids 2008, 22 (7), 1291-1297.
10. de Moraes Crizel, T.; Jablonski, A.; de Oliveira Rios, A.; Rech, R.; Flores, S. H., Dietary fiber from orange byproducts as a potential fat replacer. LWT-Food Science and Technology 2013, 53 (1), 9-14.
11. Peng, ×.; Yao, Y., Carbohydrates as fat replacers. Annual Review of Food Science and Technology 2017, 8, 331-351.
12. Laneuville, S. I.; Paquin, P.; Turgeon, S. L., Formula optimization of a low-fat food system containing whey protein isolate-xanthan gum complexes as a fat replacer. Journal of Food Science 2005, 70 (8), s513-s519.
13. Baldelli, A.; Boraey, M. A.; Nobes, D. S.; Vehring, R., Analysis of the particle formation process of structured microparticles. Molecular Pharmaceutics 2015, 12 (8), 2562-2573.
14. Liu, W.; Chen, X.; Selomulya, C., On the spray drying of uniform functional microparticles. Particuology 2015, 22, 1-12.
15. Pratap-Singh, A.; Leiva, A., Double fortified (iron and zinc) spray-dried microencapsulated premix for food fortification. Food Science & Technology. 2021, 151:112189.
16. Baldelli, A.; Power, R. M.; Miles, R. E.; Reid, J. P.; Vehring, R., Effect of crystallization kinetics on the properties of spray dried microparticles. Aerosol Science and Technology 2016, 50 (7), 693-704.
17. Guven, M.; Yasar, K.; Karaca, O.; Hayaloglu, A., The effect of inulin as a fat replacer on the quality of set-type low-fat yogurt manufacture. International Journal of Dairy Technology 2005, 58 (3), 180-184.
18. O'Brien, S. P.; Smith, M.; Ling, H.; Phillips, L.; Weber, W.; Lydon, J.; Maloney, C.; Ledbetter, S.; Arbeeny, C.; Wawersik, S., Glomerulopathy in the KK. Cg-Ay/J mouse reflects the pathology of diabetic nephropathy. Journal of Diabetes Research 2013, 2013:1-13.
19. Beirão-dₐ-Costa, S.; Duarte, C.; Bourbon, A. I.; Pinheiro, A. C.; Januário, M. I. N.; Vicente, A. A.; Beirão-dₐ-Costa, M. L.; Delgadillo, I., Inulin potential for encapsulation and controlled delivery of Oregano essential oil. Food Hydrocolloids 2013, 33 (2), 199-206.
20. Tiwari, A.; Sharma, H. K.; Kumar, N.; Kaur, M., The effect of inulin as a fat replacer on the quality of low-fat ice cream. International Journal of Dairy Technology 2015, 68 (3), 374-380.
21. Rodríguez-García, J.; Puig, A.; Salvador, A.; Hernando, I., Optimization of a sponge cake formulation with inulin as fat replacer: structure, physicochemical, and sensory properties. Journal of Food Science 2012, 77 (2), C189-C197.
22. Dai, S.; Jiang, F.; Corke, H.; Shah, N. P., Physicochemical and textural properties of mozzarella cheese made with konjac glucomannan as a fat replacer. Food Research International 2018, 107, 691-699.
23. Dai, S.; Corke, H.; Shah, N. P., Utilization of konjac glucomannan as a fat replacer in low-fat and skimmed yogurt. Journal of Dairy Science 2016, 99 (9), 7063-7074.
24. Wardhani, D. H.; Ulya, H. N.; Nugroho, F.; Sasongko, S. B.; Hadiyarto, A.; Nugroho, A., Vitamin C encapsulation by a gelation method using deacetylated glucomannan as a matrix. Journal of King Saud University-Science 2020, 32 (7), 2924-2930.
25. Belorio, M.; Sahagún, M.; Gómez, M., Psyllium as a fat replacer in layer cakes: Batter characteristics and cake quality. Food and Bioprocess Technology 2019, 12 (12), 2085-2092.
26. Beikzadeh, S.; Peighardoust, S.; Beikzadeh, M.; Javar-Abadi, M. A.; Homayouni-Rad, A., Effect of psyllium husk on physical, nutritional, sensory and staling properties of dietary prebiotic sponge cake. Czech Journal of Food Sciences 2016, 34 (6), 534-540.
27. Belščak-Cvitanović, A.; Komes, D.; Karlović, S.; Djaković, S.; Špoljarić, I.; Mršić, G.; Ježek, D., Improving the controlled delivery formulations of caffeine in alginate hydrogel beads combined with pectin, carrageenan, chitosan and psyllium. Food Chemistry 2015, 167, 378-386.
28. Attalla, N. R.; El-Hussieny, E. A., Characteristics of nutraceutical yoghurt mousse fortified with chia seeds. International Journal of Environment, Agriculture and Biotechnology 2017, 2 (4), 238873.
29. da Silva Stefani, F.; de Campo, C.; Paese, K.; Guterres, S. S.; Costa, T. M. H.; Flôres, S. H., Nanoencapsulation of linseed oil with chia mucilage as structuring material: Characterization, stability and enrichment of orange juice. Food Research International 2019, 120, 872-879.
30. Capitani, M. I.; Sandoval-Peraza, M.; Chel-Guerrero, L. A.; Betancur-Ancona, D. A.; Nolasco, S. M.; Tomas, M. C., Functional Chia Oil-in-Water Emulsions Stabilized with Chia Mucilage and Sodium Caseinate. Journal of the American Oil Chemists' Society 2018, 95 (9), 1213-1221.
31. Brütsch, L.; Stringer, F. J.; Kuster, S.; Windhab, E. J.; Fischer, P., Chia seed mucilage—a vegan thickener: isolation, tailoring viscoelasticity and rehydration. Food & Function 2019, 10 (8), 4854-4860.
32. Felisberto, M. H. F.; Wahanik, A. L.; Gomes-Ruffi, C. R.; Clerici, M. T. P. S.; Chang, Y. K.; Steel, C. J., Use of chia (Salvia hispanica L.) mucilage gel to reduce fat in pound cakes. LWT-Food Science and Technology 2015, 63 (2), 1049-1055.
33. Baldelli, A.; Wells, S.; Pratap-Singh, A., Impact of Product Formulation on Spray-Dried Microencapsulated Zinc for Food Fortification. Food and Bioprocess Technology 2021, 14 (12), 2286-2301.
34. Singh, A. P.; Siddiqui, J.; Diosady, L. L., Characterizing the pH-dependent release kinetics of food-grade spray drying encapsulated iron microcapsules for food fortification. Food and Bioprocess Technology 2018, 11 (2), 435-446.
35. Purnamayati, L.; Dewi, E.; Kurniasih, R. In Phycocyanin stability in microcapsules processed by spray drying method using different inlet temperature, IOP Conference Series: Earth and Environmental Science, 2018; 116:12076.
36. Wittner, M.; Karbstein, H.; Gaukel, V. In Spray drying of high viscous food concentrates: Investigations on the applicability of an Air-Core-Liquid-Ring (ACLR) nozzle for liquid atomization, IDS 2018. 21st International Drying Symposium Proceedings, Editorial Universitat Politécnica de València: 2018; pp 1221-1228.
37. Baldelli, A.; Trivanovic, U.; Sipkens, T. A.; Rogak, S. N., On determining soot maturity: A review of the role of microscopy- and spectroscopy-based techniques. Chemosphere 2020, 126532.
38. Rogak, S. N.; Flagan, R. C.; Nguyen, H. V., The mobility and structure of aerosol agglomerates. Aerosol Science and Technology 1993, 18 (1), 25-47.
39. Ferraz-Albani, L. A.; Baldelli, A.; Knapp, C. J.; Jäger, W.; Vehring, R.; Nobes, D. S.; Olfert, J. S.; Kostiuk, L. W., Enhanced evaporation of microscale droplets with an infrared laser. Journal of Heat Transfer 2017, 139 (1).
40. Li, Y.; Liu, H.; Xie, Y.; Shabani, K. I.; Liu, X., Preparation, characterization and physicochemical properties of Konjac glucomannan depolymerized by ozone assisted with microwave treatment. Food Hydrocolloids 2021, 119, 106878.
41. Antigo, J. L. D.; Stafussa, A. P.; de Cassia Bergamasco, R.; Madrona, G. S., Chia seed mucilage as a potential encapsulating agent of a natural food dye. Journal of Food Engineering 2020, 285, 110101.
42. Campos, B. E.; Ruivo, T. D.; dₐ Silva Scapim, M. R.; Madrona, G. S.; Bergamasco, R. d. C., Optimization of the mucilage extraction process from chia seeds and application in ice cream as a stabilizer and emulsifier. LWT-Food Science and Technology 2016, 65, 874-883.
43. Coorey, R.; Tjoe, A.; Jayasena, V., Gelling properties of chia seed and flour. Journal of Food Science 2014, 79 (5), E859-E866.
44. Abdi, H.; Williams, L. J., Principal component analysis. Wiley Interdisciplinary Reviews: Computational Statistics 2010, 2 (4), 433-459.
45. Tarakçi, Z.; Yildirim, M., Effects of ghee and olive oil usage on cocoa hazelnut spreads during storage. Journal of Food Processing and Preservation 2021, 45 (3)
46. Merrill, A. L.; Watt, B. K., Energy value of foods: basis and derivation. US Department of Agriculture: 1955.
47. Chemat, F.; Khan, M. K., Applications of ultrasound in food technology: processing, preservation and extraction. Ultrasonics Sonochemistry 2011, 18 (4), 813-835.
48. Chaves, M. A.; Piati, J.; Malacarne, L. T.; Gall, R. E.; Colla, E.; Bittencourt, P. R.; de Souza, A. H.; Gomes, S.; Matsushita, M., Extraction and application of chia mucilage (Salvia hispanica L.) and locust bean gum (Ceratonia siliqua L.) in goat milk frozen dessert. Journal of Food Science and Technology 2018, 55 (10), 4148-4158.
49. Capitani, M. I.; Ixtaina, V. Y.; Nolasco, S. M.; Tomás, M. C., Microstructure, chemical composition and mucilage exudation of chia (Salvia hispanica L.) nutlets from Argentina. Journal of the Science of Food and Agriculture 2013, 93 (15), 3856-3862.
50. da Silveira Ramos, I. F.; Magalhães, L. M.; do O Pessoa, C.; Ferreira, P. M. P.; dos Santos Rizzo, M.; Osajima, J. A.; Silva-Filho, E. C.; Nunes, C.; Raposo, F.; Coimbra, M. A., New properties of chia seed mucilage (Salvia hispanica L.) and potential application in cosmetic and pharmaceutical products. Industrial Crops and Products 2021, 171, 113981.
51. Vehring, R., Pharmaceutical particle engineering via spray drying. Pharmaceutical Research 2008, 25 (5), 999-1022.
52. Gharsallaoui, A.; Roudaut, G.; Chambin, O.; Voilley, A.; Saurel, R., Applications of spray-drying in microencapsulation of food ingredients: An overview. Food Research International 2007, 40 (9), 1107-1121.
53. I Ré, M., Microencapsulation by spray drying. Drying Technology 1998, 16 (6), 1195-1236.
54. Foegeding, E.; Drake, M., Invited review: Sensory and mechanical properties of cheese texture. Journal of Dairy Science 2007, 90 (4), 1611-1624.
55. da Costa, J. M. G.; Borges, S. V.; Hijo, A. A. C. T.; Silva, E. K.; Marques, G. R.; Cirillo, M. A. n.; Azevedo, V. M. d., Matrix structure selection in the microparticles of essential oil oregano produced by spray dryer. Journal of Microencapsulation 2013, 30 (8), 717-727.
56. Baldelli, A.; Vehring, R., Control of the radial distribution of chemical components in spray-dried crystalline microparticles. Aerosol Science and Technology 2016, 50 (10), 1130-1142.
57. Sanchez, C.; Klopfenstein, C.; Walker, C., Use of carbohydrate-based fat substitutes and emulsifying agents in reduced-fat shortbread cookies. Cereal Chemistry 1995, 72 (1), 25-29.
58. Upadhyay, R.; Aktar, T.; Chen, J., Perception of creaminess in foods. Journal of Texture Studies 2020, 51 (3), 375-388.
59. Kew, B.; Holmes, M.; Stieger, M.; Sarkar, A., Review on fat replacement using protein-based microparticulated powders or microgels: A textural perspective. Trends in Food Science & Technology 2020, 106, 457-468.
60. Panchev, I.; Delchev, N.; Kovacheva, D.; Slavov, A., Physicochemical characteristics of inulins obtained from Jerusalem artichoke (Helianthus tuberosus L.). European Food Research and Technology 2011, 233 (5), 889-896.
61. Wardhani, D. H.; Vázquez, J. A.; Ramdani, D. A.; Lutfiati, A.; Aryanti, N.; Carhyono, H., Enzymatic purification of glucomannan from Amorphophallus ancophyllus using a-amylase. Bioscience Journal, 2019, 277-288
62. Muñoz, L. A.; Zúñiga-López, M. C.; Moncada, M.; Haros, C. M., Physicochemical and functional properties of soluble fiber extracted from two phenotypes of chia (Salvia hispanica L.) seeds. Journal of Food Composition and Analysis 2021, 104, 104138.
63. Baldelli, A.; Vehring, R., Analysis of cohesion forces between monodisperse microparticles with rough surfaces. Colloids and Surfaces A: Physicochemical and Engineering Aspects 2016, 506, 179-189.
64. Reid, J. P.; Bertram, A. K.; Topping, D. O.; Laskin, A.; Martin, S. T.; Petters, M. D.; Pope, F. D.; Rovelli, G., The viscosity of atmospherically relevant organic particles. Nature Communications 2018, 9 (1), 1-14.
65. Sun, H.; Weaver, C. M., Decreased iron intake parallels rising iron deficiency anemia and related mortality rates in the US population. The Journal of Nutrition 2021, 151 (7): 1947-55.
66. Zouari, A.; Mtibaa, I.; Triki, M.; Jridi, M.; Zidi, D.; Attia, H.; Ayadi, M. A., Effect of spray-drying parameters on the solubility and the bulk density of camel milk powder: a response surface methodology approach. International Journal of Dairy Technology 2020, 73 (3), 616-624.
67. Antigo, J. L. D.; Bergamasco, R. d. C.; Madrona, G. S., How drying methods can influence the characteristics of mucilage obtained from chia seed and psyllium husk. Ciência Rural 2020, 50 (8)
68. Qi, M. Sunflower stalk pith fibre: Investigation on oil holding capacity, oil-fibre interaction, and related application in food. University of Guelph, 2017.
69. Hu, Y.-T.; Ting, Y.; Hu, J.-Y.; Hsieh, S.-C., Techniques and methods to study functional characteristics of emulsion systems. Journal of Food and Drug Analysis 2017, 25 (1), 16-26.
70. Paradiso, V. M.; Giarnetti, M.; Summo, C.; Pasqualone, A.; Minervini, F.; Caponio, F., Production and characterization of emulsion filled gels based on inulin and extra virgin olive oil. Food Hydrocolloids 2015, 45, 30-40.
71. Fidel, R. B.; Laird, D. A.; Thompson, M. L.; Lawrinenko, M., Characterization and quantification of biochar alkalinity. Chemosphere 2017, 167, 367-373.
72. Orifici, S. C.; Capitani, M. I.; Tomás, M. C.; Nolasco, S. M., Optimization of mucilage extraction from chia seeds (Salvia hispanica L.) using response surface methodology. Journal of the Science of Food and Agriculture 2018, 98 (12), 4495-4500.
73. Lario, Y.; Sendra, E.; Garcia-Pérez, J.; Fuentes, C.; Sayas-Barberá, E.; Fernández-López, J.; Perez-Alvarez, J., Preparation of high dietary fiber powder from lemon juice by-products. Innovative Food Science & Emerging Technologies 2004, 5 (1), 113-117.
74. Darwish, A. M.; Khalifa, R. E.; El Sohaimy, S. A., Functional properties of chia seed mucilage supplemented in low fat yoghurt. Alexandria Science Exchange Journal 2018, 39, 450-459.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value 10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
and if from the context the person of ordinary skill in the art would understand that values within a certain range are substantially equivalent to 10 because the values with the range would be understood to provide substantially the same result as the value 10 then “about 10” also includes:
   in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1-39. (canceled)

40. The microparticle composition as defined in claim 50, wherein the viscosity of the composition is not less than about 35 Pa·s.

41. The microparticle composition as defined in claim 50, wherein the solubility of the composition is not less than about 85%.

42. The microparticle composition as defined in claim 50, wherein the swelling capacity of the composition is not less than about 80%.

43. The microparticle composition as defined in claim 50, wherein the emulsification stability of the composition is not less than about 75%.

44. The microparticle composition as defined in claim 50, wherein the water holding capacity of the composition is not less than about 25%.

45. The microparticle composition as defined in claim 50, wherein the oil holding capacity of the composition is not less than about 10%.

46. The microparticle composition as defined in claim 50, wherein the average diameter of the microparticles is less than about 30 μm.

47-49. (canceled)

50. A microparticle composition comprising:
a plurality of dietary fibers, the plurality of dietary fibers comprising:
about 10% wt. to about 75% wt. of a first dietary fiber comprising chia mucilage;
a second dietary fiber comprising a mixture of about 20 wt. % to about 60 wt. % of konjac glucomannan and about 2 wt. % to about 30 wt. % of psyllium husk; and
about 0 wt. % to about 40 wt. % of a third dietary fiber comprising inulin.

51. Use of a microparticle composition as defined in claim 50 as a fat replacement in a food product.

52. Use of a microparticle composition as defined in claim 50 to replace some or substantially all of an oil content in a food product.

53. A method of using a microparticle composition as defined in claim 50 to decrease the total calories of a food product by greater than about 50% by replacing some or substantially all of the fat contained in the food product with the microparticle composition.

54. (canceled)

55. A method of using a microparticle composition as defined in claim 50 to reduce the total unsaturated fat in a food product by greater than about 20% by replacing some or substantially all of the fat contained in the food product with the microparticle composition.

56-58. (canceled)

59. The method as defined in claim 86, wherein the drying of the emulsion comprises one or more of spray-drying, freeze-drying and spray freeze-drying of the emulsion.

60-69. (canceled)

70. The method as defined in claim 86, wherein the drying of the emulsion comprises forming a microparticle with an average diameter of less than about 30 μm.

71-74. (canceled)

75. The method as defined in claim 86, further comprising extracting the chia mucilage from chia seeds before mixing the chia mucilage in the solvent.

76. The method as defined in claim 75, wherein the extracting of the chia mucilage comprises:
solubilizing the chia seeds by mixing the chia seeds in a solvent; and
separating the chia mucilage from the chia seeds.

77. The method as defined in claim 76, wherein the extracting of the chia mucilage further comprises dehydrating the chia mucilage after separating the chia mucilage from the chia seeds.

78-85. (canceled)

86. The method of making a microparticle composition comprising:
mixing chia mucilage, konjac glucomannan, psyllium husk, and inulin in a solvent to form an emulsion;
homogenizing the emulsion; and
drying the emulsion to form microparticles.

87. The method of making a microparticle composition comprising:
mixing about 10-75% wt. of chia mucilage, about 20-60% wt. of konjac glucomannan, about 20-60% wt. of psyllium husk, and about 0-40% wt. of inulin in a solvent to form an emulsion;
homogenizing the emulsion; and
drying the emulsion to form microparticles.

88. The method as defined in claim 87, wherein the drying of the emulsion comprises forming a microparticle with an average diameter of less than about 30 μm.
